(19) United States
(12) Patent Application Publication
(10) Pub. No.: US 2026/0361554 A1
(43) Pub. Date: Nov. 12, 2026

(54) Physically Unclonable Functions

(71) Applicant: Cirrus Logic International Semiconductor Ltd., Edinburgh (GB)

(72) Inventors: John P. LESSO, Edinburgh (GB); Scott P. WARRICK, Georgetown, TX (US)

(73) Assignee: Cirrus Logic International Semiconductor Ltd., Edinburgh (GB)

(21) Appl. No.: 19/410,403

(22) Filed: Dec. 5, 2025

Related U.S. Application Data
(60) Provisional application No. 63/810,863, filed on May 23, 2025.
(60) Provisional application No. 63/803,051, filed on May 9, 2025.

(51) Int. Cl. H04L 9/32

(52) U.S. Cl. CPC H04L 9/3278

(57) ABSTRACT

An apparatus, comprising: at least one primary component; a security die comprising a physically unclonable function (PUF) and processing circuitry; an electrical interface electrically coupled to the at least one primary component, wherein the security die is configured to generate a unique response to a challenge received at the security die, the unique response dependent on the PUF and at least one electrical characteristic of one or both of the primary component and the electrical interface.

### TECHNICAL FIELD

The present disclosure relates to physically unclonable functions.

### BACKGROUND

Physically unclonable functions (PUFs) are widely used in cryptographic key generation. Traditional PUFs leverage uncontrollable manufacturing variations in physical materials to produce unique and unpredictable responses to given inputs (referred to as challenges). These variations can be used to derive unique fingerprints for a semiconductor device.

Conventional PUFs tend to rely solely on internal die characteristics which have the potential to be replicated or bypassed in security attacks.

### SUMMARY

According to an aspect of the disclosure, there is provided an apparatus, comprising: at least one primary component; a security die comprising a physically unclonable function (PUF) and processing circuitry; an electrical interface electrically coupled to the at least one primary component, wherein the security die is configured to generate a unique response to a challenge received at the security die, the unique response dependent on the PUF and at least one electrical characteristic of one or both of the primary component and the electrical interface.

The security die my be configured to generate the unique response in dependence on one or more of the following: a capacitive profile of the electrical interface; a complex impedance of the electrical interface; a pin-to-pin transfer characteristic of the electrical interface; and an impedance profile of connections between sub-components of the primary component; and a thermal behaviour of the primary component.

The at least one of electrical characteristic may comprise a plurality of different electrical characteristics.

The electrical interface may be electrically coupled to the security die.

The electrical interface may be electrically coupled to one or more additional components of the apparatus.

The electrical interface may comprise external connections to the apparatus.

The apparatus may comprise a packaged IC. The at least one primary component may comprise one or more primary dies. The one or more primary dies and the security die may be co-packaged in the packaged IC.

The primary component may comprise a battery. The apparatus may comprise a battery pack comprising the battery and a packaged security IC comprising the security die.

The security die may be configured to generate the unique response in dependence on one or more of the following: an open circuit voltage profile of one or more cells of the battery; and a thermal behaviour of the battery.

The primary component may comprise a camera component. The apparatus may comprise a camera module comprising the camera component and a packaged security IC comprising the security die.

The apparatus may further comprise one or more sensors configured to detect tampering of the apparatus.

The one or more sensors may comprise an optical sensor configured to detect removal of a physical component of the apparatus.

The one or more sensors may comprise a resistive sensor coupled to an internal layer of a package of the apparatus. The resistive sensor may be configured to detect opening or bending of the package.

The one or more sensors may comprise a temperature sensor configured to monitor thermal variations of the primary component to detect thermal tampering of the system.

The apparatus may further comprise processing circuitry configured to: compare a model of the one or more electrical characteristics to the one or more electrical characteristics; and determine that tampering of the primary component has occurred based on the comparison.

The processing circuitry may be configured to adapt the model over time.

The adaptation of the model may be based on aging of the primary component, or a charging profile of a battery of the primary component.

The PUF die may be configured to generate a first cryptographic key based on the one or more electrical characteristics and the electrical interface.

The PUF die may be configured to generate the first cryptographic key based on a vector of the one or more electrical characteristics.

The PUF die may comprise a fuzzy extractor to generate the first cryptographic key.

The fuzzy extractor may be configured to generate helper data for use in key regeneration. The helper data may encode error correcting information associated with the at least one electrical characteristic.

The PUF die may be further configured to generate a second cryptographic key based on the same at least one electrical characteristic used to generate the first cryptographic key and the helper data; and compare the first cryptographic key to the second cryptographic key.

The PUF die may be configured to output an integrity decision based on the comparison.

According to another aspect of the disclosure, there is provided an electronic device comprising an apparatus as described above.

The device may comprise one of a smartphone, a communications device, a mobile computing device, a laptop computer, a tablet computer, a games console, a remote-control device, a home automation controller or a domestic appliance, a toy, a robot, an audio player, a video player, or a mobile telephone, and a smartphone.

According to another aspect of the disclosure, there is provided semiconductor device, comprising: a first set of external pins; a second set of external pins; a primary component coupled with the first set of external pins; and a security component comprising a physically unclonable function (PUF), the PUF coupled to the second set of external pins in a cryptographically secure manner, wherein the primary component is coupled to the security component in a secure manner.

The semiconductor device may comprise a packaged integrated circuit.

The primary component may be configured to perform one or more of analog, digital, and mixed signal processing.

The primary component may comprise a battery or a camera module.

According to another aspect of the disclosure, there is provided an electronic device comprising a delay element, a memory system, or a PUF as described above. The device may comprise one of a mobile computing device, a laptop computer, a tablet computer, a games console, a remote-control device, a home automation controller or a domestic appliance, a toy, a robot, an audio player, a video player, or a mobile telephone, and a smartphone.

Throughout this specification the word "comprise", or variations such as "comprises" or "comprising", will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is a schematic diagram of an integrated circuit package comprising a security integrated circuit;

FIG. 2 is a schematic diagram of a system comprising a security integrated circuit; and

FIG. 3 is a schematic diagram of a fuzzy extractor which may be implemented by the security integrated circuit of FIGS. 1 and 2.

### DESCRIPTION OF EMBODIMENTS

Embodiments of the present disclosure aim to address or at least ameliorate one or more of the challenges associated with conventional PUFs.

It is proposed to provide a new PUF architecture in which a PUF die is integrated within a package or module alongside a primary component or die, or within a module alongside a non-integrated component, such as a battery or a camera module. Such a PUF die may derive its entropy (or randomness) not only from its internal physical characteristics, but also from the electrical characteristics of its connections to the primary die or device and/or the primary die or device itself.

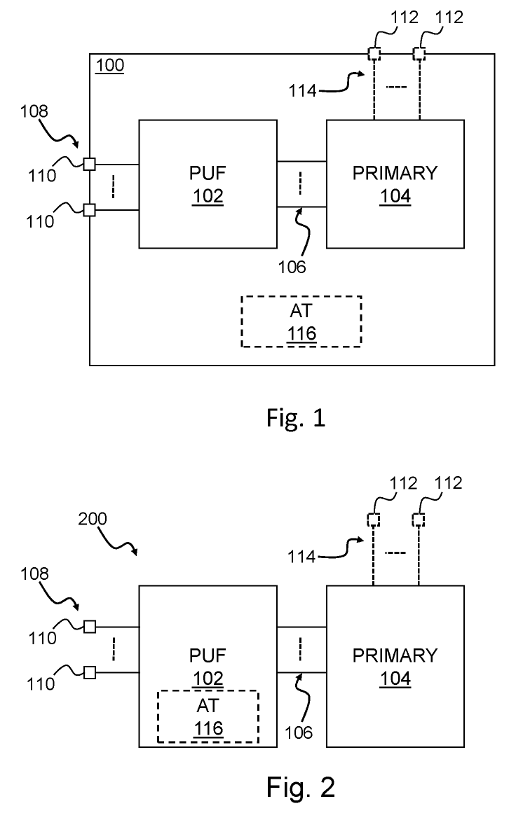

FIG. 1 is a schematic diagram of an example integrated circuit (IC) package 100 comprising a PUF die 102 (or security die) and a primary component 104.

The primary component 104 may comprise circuitry for implementing one or more primary functions of the IC package 100. For example, the primary component 104 may comprise analog, digital, and/or mixed signal electronics for implementing such functions. The primary component 104 in this example may be an IC on a semiconductor die packaged in the IC package 100 with the PUF die 102.

The PUF die 102 is coupled to the primary component 104 via an internal interface 106. The internal interface 106 may comprise a plurality of electrical connections.

The PUF die 102 is coupled to an external interface 108 of the IC package 100, which in this example comprises a plurality of external pins 110 of the IC package 100, to allow for the PUF die 102 to be interrogated, for example as part of a challenge-response operation.

The primary component 104 may optionally be coupled to one or more external pins 112 of the IC package 100 via a primary interface 114. The external pins 112 may be provided, for example, for high-voltage connections, sensing, etc. Additionally, or alternatively, the primary interface 114 may provide connections to other components of the IC package 100 (not shown).

As noted above, the PUF die 102 may be interrogated as part of a challenge-response operation. For example, a challenge (typically a bitstring or selection signal) may be input via the external pins 110 of the IC package 100 which may be received by the PUF die 102. In response to the challenge, the PUF die 102 may generate a response, which may be a bitstring determined at least partially by the unique physical characteristics of the PUF die 102. In addition, the PUF die 102 may generate the response based at least partially on one or more characteristics of other elements of the IC package 100. For example, the PUF die 102 may generate the response based at least partially on the internal interface 106 between the PUF die 102 and the primary component 104. For example, the PUF die 102 may generate response based at least partially on the primary interface 114. For example, the PUF die 102 may generate the response based on a characteristic of the primary component 104.

Optionally, the IC package 100 may comprise anti-tamper circuitry 116. The anti-tamper circuitry 116 may be provided as part of the PUF die 102 (e.g. on the PUF die 102) or may alternatively be provided as a separate die packaged within the IC package 100. The anti-tamper circuitry 116 may be configured to detect tampering of the IC package 100. For example, the anti-tamper circuitry 116 may be configured to detect de-lidding or opening of the IC package 100. The anti-tamper circuitry 116 may comprise one or more sensors. Such sensors may comprise an optical sensor for detecting light or a change in a light characteristic within the IC package 100. Additionally, or alternatively, the anti-tamper circuitry 116 may comprise a resistive sensor. The resistive sensor may be coupled to an internal wall of the IC package 100 and may be configured to detect opening or bending of the IC package 100.

On detection of tampering by the anti-tamper circuitry 116, the PUF die 102 may be subsequently configured to fail authentication in response to a challenge. For example, the PUF die 102 may be configured not to generate any response to subsequent challenges. Alternatively, the PUF die 102 may be configured to generate an imitation response to subsequently received challenges. Such imitation responses would not pass a challenge-response query.

It will be appreciated that each of the PUF die 102, the primary component 104, and the internal interface 106 exhibit entropy due to process variations in manufacture of the IC package 100. Thus, by using both the entropy the internal interface 106, the primary interface 114, and/or the primary component 104 in addition to that of the PUF die 102 to generate the response, the overall entropy of the response can be increased, thereby improving the resilience of the PUF die 102 to security attacks.

FIG. 2 is a schematic diagram of a system 200 comprising the PUF die 102 and the primary component 104. The system 200 differs from the arrangement in FIG. 1 only in that the PUF die 102 and primary component 202 are not packaged in the common package 100 but are instead provided separately. In this example, the primary component 202 may be a separate device or module to the PUF die 102. Non-limiting examples of the primary component 202 include a battery pack, a battery, and a camera module (e.g. a camera module for installation into a smartphone or other computing device). The system 200 is similar to the arrangement shown in FIG. 1 in that the PUF die 102 is electrically coupled to the primary component 202 via the interface 106, and in that the PUF die 102 can be interrogated via the external interface 108. For example, the PUF die 102 may be integrated or packaged into an IC package, and the external pins 110 may be part of that IC package. The internal interface 106 in this example may comprise one or more pins or terminals of the PUF die 102, the primary component 202, or both. The primary interface 114 may be for connecting the primary component 104 to one or more other components of the system 200. For example, where the primary component 104 is a battery pack, the primary interface 114 may comprise battery terminals.

In this example, when provided, the anti-tamper circuitry 116 is provided in the PUF die 102. The anti-tamper circuitry 116 may be configured to detect tampering of the primary component 104. For example, where the primary component 104 comprises a battery cell, the anti-tamper circuitry 116 may be configured to determine thermal behaviour of the battery cell and use such information to bind the die IC 102 not only to the physical location (e.g. in a battery pack), but to the actual physical identity of the battery. It will be appreciated that thermal characteristics have a high level of entropy, are difficult to replicate, and are sensitive to internal structure, contact conditions, and materials. Thermal characteristics of the primary component 104 thus provide a secure, high-entropy characteristic which is difficult to reliably replicate. The anti-tamper circuitry 116 may therefore comprise one or more temperature sensors for monitoring thermal characteristics of the primary component 104. Preferably, the thermal behaviour is monitored while the primary component 104 is in a known state (e.g. during 1C charging). To ensure reliable measurements of thermal characteristics of the primary component 104, it may be advantageous to mount the anti-tamper circuitry 116 proximate the primary component 104 (for example by mounting the PUF die 102 such that it shares a thermal path with a battery cell of the primary component 104).

As with the implementation shown in FIG. 1, it will be appreciated that each of the PUF die 102, the primary component 104, the primary interface 114, and the interface internal 106 exhibit entropy due to process variations in manufacture system 200. Thus, by using both the entropy the internal interface 106, the primary interface 114 and/or the primary component 104 in addition to that of the PUF die 102 to generate the response, the overall entropy of the response can be increased, thereby improving the resilience of the PUF die 102 to security attacks. Specifically, by harnessing entropy associated with the primary component 104 and/or connections thereto, to clone the response of the PUF die 102, a potential attacker would need to firstly copy the PUF die 102’s internal cryptographic behaviour, and then precisely mimic the physical and electrical characteristics of the primary component (e.g. board, package, microchip, configuration etc.).

Thus, the electrical fingerprint of the system 200 becomes a binding element of security which may be used for device authentication. The response of the PUF die 102 to a challenge is contingent not only in an internal state or characteristic of the PUF die 102, but also on extrinsic electrical features or characteristics arising from the interfaces 106, 114 and/or the primary component 104 itself.

There are several electrical characteristics of the primary component 104 that could be used as a source of entropy by the PUF die 102 to construct the PUF. Each of these properties are inherently unique doe to process variations, solder joint imperfections, trace impedance, board layout differences etc., none of which can be reliably cloned or simulated. The result is a PUF whose behaviour is inseparably linked to its exact physical instantiation, rather than just its silicon.

Non-limiting examples of such characteristics are as follows.

For example, capacitive profiling may be used. For example, parasitic capacitance between input/output pins of the PUF die 102 and connections to/from the primary component may be used. This may include mutual coupling and self-capacitance to ground.

For example, a complex impedance of the primary component 104 may be used as a fingerprint of the primary component 104. For example, the primary component 104 may be interrogated with a time-varying stimulus (e.g. a frequency sweep or chip applied to pins of the primary component) and an impedance of the primary component 104 measured over a frequency range (e.g. 100 kHz to 10 MHz). In doing so, a unique signature may be obtained from the frequency response of the primary component 104 to the stimulus.

For example, pin-to-pin transfer characteristics may be used as a source of entropy for generating the PUF response. Signals may be transmitted from the PUF die 102 to the primary component 104 and characteristics of the transfer of those signals may be used to determine characteristics of the interfaces 106, 114. Such characteristics may comprise a rise time, fall time, or propagation delay of signals. These characteristics may be used to generate see values for the generation of secure keys in the PUF die 102 or a response by the PUF die 102 to a challenge.

For example, electrochemical impedance spectroscopy (EIS) or chronoamperometry (CA) may be used to generate a component signature of the primary component 104. This component signature may be used, for example, as part of a PUF signature and/or to gate a response of the PUF. For example, an initial measurement of component signature may be performed in an initialisation or calibration mode. Subsequently, in a measurement mode, another measurement of the same component signature may be performed. If the subsequently measured signature varies from the initial component signature by more than a threshold amount, this result may prevent the PUF response from being output by the PUF die 102. Use of EIS or CA component signature may be particularly appropriate when the primary component 104 comprises a battery. In which case, EIS may be performed on one or more cell of the battery.

In another example, welds or connections between battery cells of sub-modules of the primary component may be used a source of entropy by the PUF die 102.

In another example, differences in potential across different cells may be used as a source of entropy by the PUF die 102. It will be appreciated that the relative pattern of voltages across different battery cells may shift over time. However, the initial voltage distribution “fingerprint” and drift may be used.

It will be appreciated that a single electrical characteristic may be used by the PUF die 102 to construct the PUF. Alternatively, the PUF die 102 may be configured to utilise a plurality of electrical characteristics of one or both of the interfaces 106, 114 and/or the primary component 104.

For example, the PUF die 102 may be configured to obtain a vector of electrical features (i.e. different electrical characteristics) of the interfaces 106, 114 and/or the primary component 104. Each feature in the vector may relate to a different electrical characteristic (e.g. a capacitive profile and a complex impedance). Additionally, or alternatively, a vector may comprise multiple features representing the same electrical feature (e.g. impedance) measured at a plurality of locations (for example multiple pins of the primary component 104).

When the primary component 104 comprises a battery, the electrical characteristic(s) of the primary component 104 may be obtained at a known state of charge (SoC) and temperature. Doing so may minimize variation in the measured electrical characteristics in addition to enabling like-for-like measurements to be made at a later date for later comparison. If the ageing model for a battery of the primary component 104 is known, the ageing model may be used to modify the constructed PUF (e.g. signature of the component) as the battery ages. Additionally, or alternatively, an open circuit voltage (OCV) of a battery of the primary component 104 may be used to modify the PUF. It will be appreciated that the OCV of the battery will change as the battery ages. The PUF die 102 may be configured to monitor a number of charging cycles of battery or battery cells therein. Based on this monitoring, the PUF die 102 may update the ageing model accordingly. The battery model may be used by the PUF die 102 for anti-tamper detection. For example, the PUF die 102 may measure characteristics of the battery and compare these with a model of the battery taking into account the number of charging cycles recorded as having taken place. A difference may indicate that the primary component 104 has been replaced or switched out.

Particularly when the primary component 104 comprises a battery, the system 200 may be configured to implement a component passport system to guarantee an integrity of the primary component 104. For example, the PUF IC 102 may store a digital record (component passport) which uniquely identifies the primary component 104. The digital record may track the lifecycle of the primary component 104 (e.g. battery) from manufacturing through to usage, maintenance, and/or recycling. The digital record may be provided to support regulatory compliance (e.g. with battery regulations). The digital record may comprise data concerning one or more of chemical composition, manufacturing origin, performance history, and environmental impact associated with the primary component 104. In doing so, the digital record may also be provided to promote sustainability and ensure traceability.

To ensure the digital record (component passport) remains tied to the primary component 104 (or the physical battery) and cannot be spoofed or cloned, the PUF die 102 may be embedded with the primary component 104. Since the PUF die 102 exploits physical variations during manufacturing to the unique response, by linking the component passport, the PUF die 102 can act as a hardware root of trust. Only a genuine component (e.g. the original battery or camera) will produce the correct response to a challenge. This ensures that the component passport data cannot be misapplied to counterfeit of tampered with components. Additionally, by coupling the response with physical measurements of the primary component 104, such as an impedance spectrum or thermal response, the component passport becomes both a digital certificate and a secure, tamper-evident representation of the primary components 104 identity and condition.

It will be appreciated that variations electrical and thermal characteristics of the interface 106 and primary component 104 may lead to changes in the response generate by the PUF die 102.

As such, it may be advantageous to use certain electrical or thermal characteristics which are deemed to be more stable than others. Accordingly, a determination may be made as to the most stable electrical characteristics of those considered for response generation by the PUF die 102. The PUF die 102 may be configured to utilise electrical characteristics deemed more stable. The PUF die 102 may be configured to discard electrical characteristics deemed to be less stable. An analysis of stability of features may be performed, for example, during enrolment or at or after manufacture.

Additionally, or alternatively, the PUF die 102 may be configured to process the electrical or thermal characteristics such that the resultant response is less susceptible to noise in measured electrical or thermal characteristics.

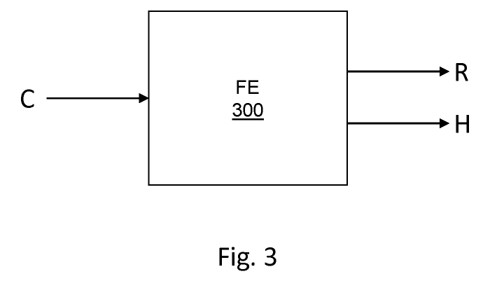

For example, the PUF die 102 may implement a fuzzy extractor 300 as shown in FIG. 3. The fuzzy extractor 300 is a cryptographic construction that enables stable, uniformly random keys to be generated from noisy or imperfect data or signals. The fuzzy extractor 300 may be configured to receive one or more electrical characteristics C, such as those described above, and generate a uniformly random key R in addition to helper data H. Advantageously, the helper data H does not reveal the random key R nor the electrical characteristics C used to generate the random key R, and so can be stored and transmitted publicly. The helper data H can, however, be used in subsequent processing of the same electrical characteristic(s) C to reproduce the same uniformly random key R.

Thus, in the context of the present disclosure, the PUF die 102 may use the fuzzy extractor 300 to generate a stable cryptographic key (the random key R) from electrical measurements of the primary and/or internal interfaces 106, 114 and/or the primary component 104, in addition to helper data H to be used at a later time for reproduction of the key R.

The helper data H may be stored in non-volatile memory (not shown) provided on the PUF die 102. The helper data H may encode error-correcting information which can be used in subsequent measurements to correct for deviations associated with ageing of the interface 106 and/or the primary component 104. As such, provided the PUF die 102 remains connected to the same primary component 104 via the same interface, with the help of the helper data H, the same random key R will be generated using the fuzzy extractor 300 despite small variations in the electrical characteristics used to generate the key R. If, however, the primary component 104 and/or the interfaces 106, 114 are tampered with or swapped out for a like-for-like component and/or interface, the measured electrical characteristics C will vary sufficiently for the resultant key R generated by the fuzzy extractor 300 to be different, despite use of helper data H. The response to the challenge will therefore not match what is expected, resulting in detection of the replacement or tampering of the interface 106 and/or primary component 104.

The fuzzy extractor 300 may generate the random key R and helper data H in two stages. In a first stage, the fuzzy extractor 300 may perform a secure sketch to obtain the helper data H. The sketch records a hint (the helper data H) that allows for future error correction. In a second stage, the fuzzy extractor 300 may implement privacy amplification, for example by applying a cryptographic hash to the electrical characteristic(s) C to obtain the random key R, to ensure the key R is uniformly random and secure.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog TM or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote control device, a home automation controller or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. An apparatus, comprising:
at least one primary component;
a security die comprising a physically unclonable function (PUF) and processing circuitry;
an electrical interface electrically coupled to the at least one primary component,
wherein the security die is configured to generate a unique response to a challenge received at the security die, the unique response dependent on the PUF and at least one electrical characteristic of one or both of the primary component and the electrical interface.

2. The apparatus of claim 1, wherein the security die is configured to generate the unique response in dependence on one or more of the following:
a capacitive profile of the electrical interface;
a complex impedance of the electrical interface;
a pin-to-pin transfer characteristic of the electrical interface; and
an impedance profile of connections between sub-components of the primary component; and
a thermal behaviour of the primary component.

3. The apparatus of claim 1, wherein the at least one of electrical characteristic comprises a plurality of different electrical characteristics.

4. The apparatus of any one of the preceding claim 1, wherein the electrical interface is electrically coupled to the security die.

5. The apparatus of claim 1, wherein the electrical interface is electrically coupled to one or more additional components of the apparatus.

6. The apparatus of claim 1, wherein the electrical interface comprises external connections to the apparatus.

7. The apparatus of claim 1, wherein the apparatus comprises a packaged IC, wherein the at least one primary component comprises one or more primary dies, and wherein the one or more primary dies and the security die are co-packaged in the packaged IC.

8. The apparatus of claim 1, wherein the primary component comprises a battery, and wherein the apparatus comprises a battery pack comprising the battery and a packaged security IC comprising the security die.

9. The apparatus of claim 8, wherein the security die is configured to generate the unique response in dependence on one or more of the following:
an open circuit voltage profile of one or more cells of the battery;
a thermal behaviour of the battery.

10. The apparatus of claim 1, wherein the primary component comprises a camera component, and wherein the apparatus comprises a camera module comprising the camera component and a packaged security IC comprising the security die.

11. The apparatus of claim 1, further comprising one or more sensors configured to detect tampering of the apparatus.

12. The apparatus of claim 11, wherein the one or more sensors comprises an optical sensor configured to detect removal of a physical component of the apparatus.

13. The apparatus of claim 11, wherein the one or more sensors comprises a resistive sensor coupled to an internal layer of a package of the apparatus, the resistive sensor configured to detect opening or bending of the package.

14. The apparatus of claim 11, wherein the one or more sensors comprises a temperature sensor configured to monitor thermal variations of the primary component to detect thermal tampering of the system.

15. The apparatus of claim 1, further comprising processing circuitry configured to:
compare a model of the one or more electrical characteristics to the one or more electrical characteristics; and
determine that tampering of the primary component has occurred based on the comparison.

16. The apparatus of claim 15, wherein the processing circuitry is configured to adapt the model over time.

17. The apparatus of claim 16, wherein the adaptation of the model is based on aging of the primary component, or a charging profile of a battery of the primary component.

18. The apparatus of claim 1, wherein the PUF die is configured to generate a first cryptographic key based on the one or more electrical characteristics and the electrical interface.

19. The apparatus of claim 18, wherein the PUF die is configured to generate the first cryptographic key based on a vector of the one or more electrical characteristics.

20. The apparatus of claim 18, wherein the PUF die comprises a fuzzy extractor to generate the first cryptographic key.

21. The apparatus of claim 20, wherein the fuzzy extractor is configured to generate helper data for use in key regeneration, the helper data encoding error correcting information associated with the at least one electrical characteristic.

22. The system of claim 21, wherein the PUF die is further configured to:
generate a second cryptographic key based on the same at least one electrical characteristic used to generate the first cryptographic key and the helper data; and
compare the first cryptographic key to the second cryptographic key.

23. The system of claim 22, wherein the PUF die is configured to output an integrity decision based on the comparison.

24. An electronic device comprising the apparatus of claim 1, wherein the device comprises one of a smartphone, a communications device, a mobile computing device, a laptop computer, a tablet computer, a games console, a remote-control device, a home automation controller or a domestic appliance, a toy, a robot, an audio player, a video player, or a mobile telephone, and a smartphone.

25. (canceled)
